(19) United States
(12) Patent Application Publication
(10) Pub. No.: US 2025/0108726 A1
(43) Pub. Date: Apr. 3, 2025

(54) METHOD FOR CONTROLLING A DISTRIBUTED DIRECT CURRENT TO DIRECT CURRENT CONVERTER SYSTEM

(71) Applicant: GM GLOBAL TECHNOLOGY OPERATIONS LLC, Detroit, MI (US)

(72) Inventors: William R. Cawthorne, Milford, MI (US); Brian A. Welchko, Oakland Township, MI (US); Bradley David Smrdel, Shelby Township, MI (US); Mohamed Kamel, Birmingham, MI (US); Carrie Bradley, Aptos (CA); Suresh Gopalakrishnan, Troy, MI (US); Chandra S. Namuduri, Troy, MI (US); David W. Walters, Sterling Heights, MI (US)

(73) Assignee: GM GLOBAL TECHNOLOGY OPERATIONS LLC, Detroit, MI (US)

(21) Appl. No.: 18/480,046

(22) Filed: Oct. 3, 2023

(51) Int. Cl. B60L 58/22; B60L 1/00; B60L 58/12

(52) U.S. Cl. CPC B60L 58/22; B60L 58/12; B60L 1/00; B60L 2210/10

(57) ABSTRACT

In an embodiment, a method is provided for controlling a plurality of converters that are coupled to a plurality of cells of a rechargeable energy storage system (RESS) and configured to supply electric current to other systems that require the electric current, the method including obtaining, via one or more sensors, cell data as to the plurality of cells, the cell data including a state-of-charge for each of the plurality of cells; obtaining other system data as to the other systems, including an amount of electric current required by the other systems; and controlling the plurality of converters, in accordance with instructions provided by a processor, based on both: the cell data, including the state-of-charge for each of the plurality of cells; and the other system data, including the amount of electric current by the other systems.

### INTRODUCTION

The technical field generally relates to platforms such as vehicles and, more specifically, to methods and systems for controlling direct current (“DC”) to DC converter systems, such as in vehicles.

Certain vehicles today have rechargeable energy storage systems (“RESS”), such as vehicle batteries, that operate high voltage systems (such a vehicle motor) as well as low voltage systems (such as a vehicle radio, seat warmer, or the like), and that utilize DC to DC converters in supplying voltage from cell groups of the RESS. However, existing vehicles may not always provide for optimal control of the converters, for example in providing optimal balancing for the cell groups and/or longevity for the converters.

Accordingly, it is desirable to provide improved methods and systems for controlling converters for RESS, such as for vehicles. Furthermore, other desirable features and characteristics of the present disclosure will become apparent from the subsequent detailed description and the appended claims, taken in conjunction with the accompanying drawings and the foregoing technical field and background.

### SUMMARY

In accordance with an exemplary embodiment, a method is provided for controlling a plurality of converters that are coupled to a plurality of cells of a rechargeable energy storage system (RESS) and that are configured to supply electric current to one or more other systems that require the electric current, the method including obtaining, via one or more sensors, cell data as to the plurality of cells, the cell data including a state-of-charge for each of the plurality of cells; obtaining other system data as to the one or more other systems, including an amount of electric current required by the one or more other systems; and controlling the plurality of converters, in accordance with instructions provided by a processor, based on both: the cell data, including the state-of-charge for each of the plurality of cells; and the other system data, including the amount of electric current by each of the one or more other systems.

Also in an exemplary embodiment, the controlling of the plurality of converters includes selecting, via the processor, a selected converter group of the plurality of converters and a selected cell group of the plurality of cells that are coupled to the selected converter group, to be utilized for providing the electric current to the one or more other systems; and selecting, via the processor, electric current commands for a magnitude of the electric current to be provided via the selected converter group and the selected cell group to the one or more other systems.

Also in an exemplary embodiment, the selected converter group and the electric current commands are selected via the processor to facilitate balancing of states of charge of the plurality of cells.

Also in an exemplary embodiment, the method further includes obtaining converter data as to operation of the plurality of converters; wherein the selected converter group and the electric current commands are also based on the converter data that also accounts for any unavailable converters and to facilitate longevity for the plurality of converters.

Also in an exemplary embodiment, the steps of the method are performed within a vehicle that includes the RESS, including the plurality of cells and the plurality of converters, and further including the one or more sensors, the processor, and the one or more other systems, and wherein of the plurality of converters include a direct current (DC) to direct current (DC) converter.

Also in an exemplary embodiment, the method further includes providing supplemental commands, via the processor, for supplemental balancing of the plurality of cells, separate and apart from the electric current commands.

Also in an exemplary embodiment, the method further includes adjusting the electric current commands based on a reserve of the electric current that is available in addition to a prioritization of the one or more other systems, including based on a respective relative criticality of the one or more other systems.

In another exemplary embodiment, a system is provided for controlling a plurality of converters that are coupled to a plurality of cells of a rechargeable energy storage system (RESS) and that are configured to supply electric current to one or more other systems that require the electric current, the system including one or more sensors and a processor. The one or more sensors are configured to obtain cell data as to the plurality of cells, the cell data including a state-of-charge for each of the plurality of cells. The processor is coupled to the one or more sensors, and is configured to at least facilitate obtaining other system data as to the one or more other systems, including an amount of electric current required by the one or more other systems; and controlling the plurality of converters, in accordance with instructions provided by the processor, based on both: the cell data, including the state-of-charge for each of the plurality of cells; and the other system data, including the amount of electric current by each of the one or more other systems.

Also in an exemplary embodiment, the processor is further configured to at least facilitate controlling the plurality of converters by selecting a selected converter group of the plurality of converters and a selected cell group of the plurality of cells that are coupled to the selected converter group, to be utilized for providing the electric current to the one or more other systems; and selecting electric current commands for a magnitude of the electric current to be provided via the selected converter group and the selected cell group to the one or more other systems; wherein the electric current commands are implemented via the selected converter group of the plurality of converters.

Also in an exemplary embodiment, the processor is further configured to at least facilitate selecting the selected converter group and the electric current commands to facilitate a balancing of states of charge of the plurality of cells.

Also in an exemplary embodiment, the processor is further configured to at least facilitate obtaining converter data as to operation of the plurality of converters; and selecting the selected converter group and the electric current commands based also on the converter data in a manner that also accounts for any unavailable converters and to facilitate longevity for the plurality of converters.

Also in an exemplary embodiment, the processor is further configured to at least facilitate providing supplemental commands for supplemental balancing of the plurality of cells, separate and apart from the electric current commands.

Also in an exemplary embodiment, the processor is further configured to at least facilitate adjusting the electric current commands based on a reserve of the electric current that is available in addition to a prioritization of the one or more other systems, including based on a respective relative criticality of the one or more other systems.

In another exemplary embodiment, a vehicle is provided that includes a rechargeable energy storage system (RESS), one or more other systems, and a control system. The RESS includes a plurality of cells and a plurality of converters that are coupled thereto and that are configured to supply electric current. The one or more other systems require the electric current and that receive the electric current from the RESS. The control system includes one or more sensors and a processor. The one or more sensors are configured to obtain cell data as to the plurality of cells, the cell data including a state-of-charge for each of the plurality of cells. The processor is coupled to the one or more sensors and to the plurality of converters, and is configured to at least facilitate obtaining other system data as to the one or more other systems, including an amount of electric current required by the one or more other systems; and controlling the plurality of converters, in accordance with instructions provided by the processor, based on both: the cell data, including the state-of-charge for each of the plurality of cells; and the other system data, including the amount of electric current by each of the one or more other systems.

Also in an exemplary embodiment, the processor is further configured to at least facilitate controlling the plurality of converters by selecting a selected converter group of the plurality of converters and a selected cell group of the plurality of cells that are coupled to the selected converter group, to be utilized for providing the electric current to the one or more other systems; and selecting electric current commands for a magnitude of the electric current to be provided via the selected converter group and the selected cell group to the one or more other systems; and the electric current commands are implemented via the selected converter group of the plurality of converters.

Also in an exemplary embodiment, the processor is further configured to at least facilitate selecting the selected converter group and the electric current commands in a manner that facilitates a balancing of states of charge of the plurality of cells.

Also in an exemplary embodiment, the processor is further configured to at least facilitate obtaining converter data as to operation of the plurality of converters; and selecting the selected converter group and the electric current commands based also on the converter data that also accounts for any unavailable converters and to facilitate longevity for the plurality of converters.

Also in an exemplary embodiment, the processor is further configured to at least facilitate providing supplemental commands for supplemental balancing of the plurality of cells, separate and apart from the electric current commands.

Also in an exemplary embodiment, one or more of the plurality of converters includes a bidirectional converter, and the providing of the supplemental commands is provided by the processor and implemented by the bidirectional converter for the supplemental balancing of the plurality of cells, separate and apart from the electric current commands.

Also in an exemplary embodiment, the processor is further configured to at least facilitate adjusting the electric current commands based on a reserve of the electric current that is available in addition to a prioritization of the one or more other systems, including based on a respective relative criticality of the one or more other systems.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes an RESS and a control system for control thereof, among various other components, in accordance with exemplary embodiments;

FIG. 2 is a functional block diagram illustrating an RESS that includes a plurality of cell groups and a plurality of DC to DC converters, and that can be implemented for the RESS in the vehicle of FIG. 1, in accordance with exemplary embodiments; and

FIGS. 3A and 3B (also collectively referred to herein as “FIG. 3”) include a flowchart of a process for controlling an RESS, and that can be implemented in connection with the vehicle of FIG. 1, including the RESS and control system thereof, and the RESS of FIG. 2, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

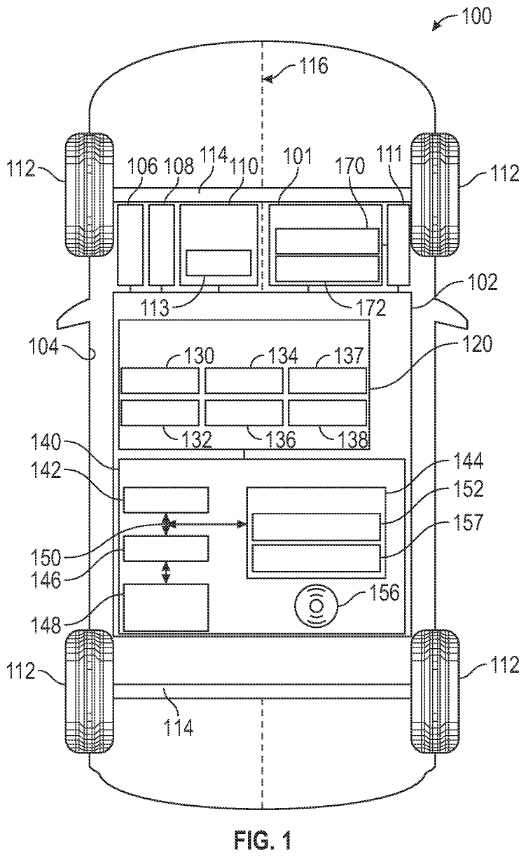

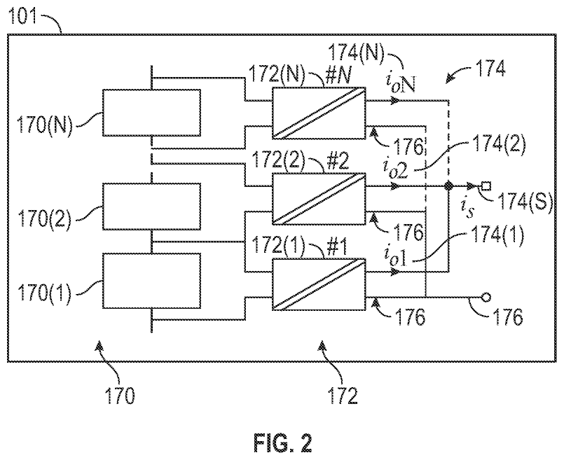

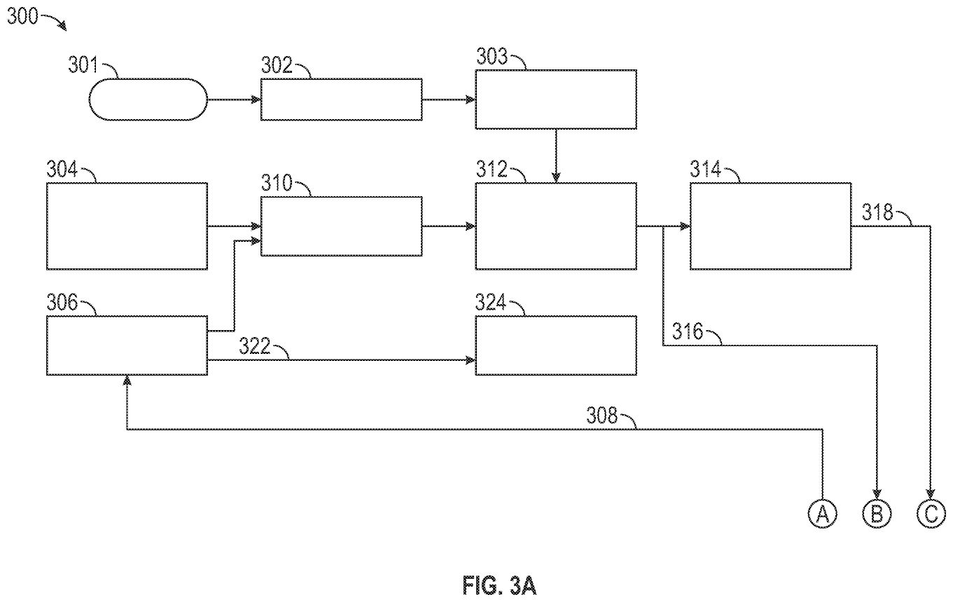

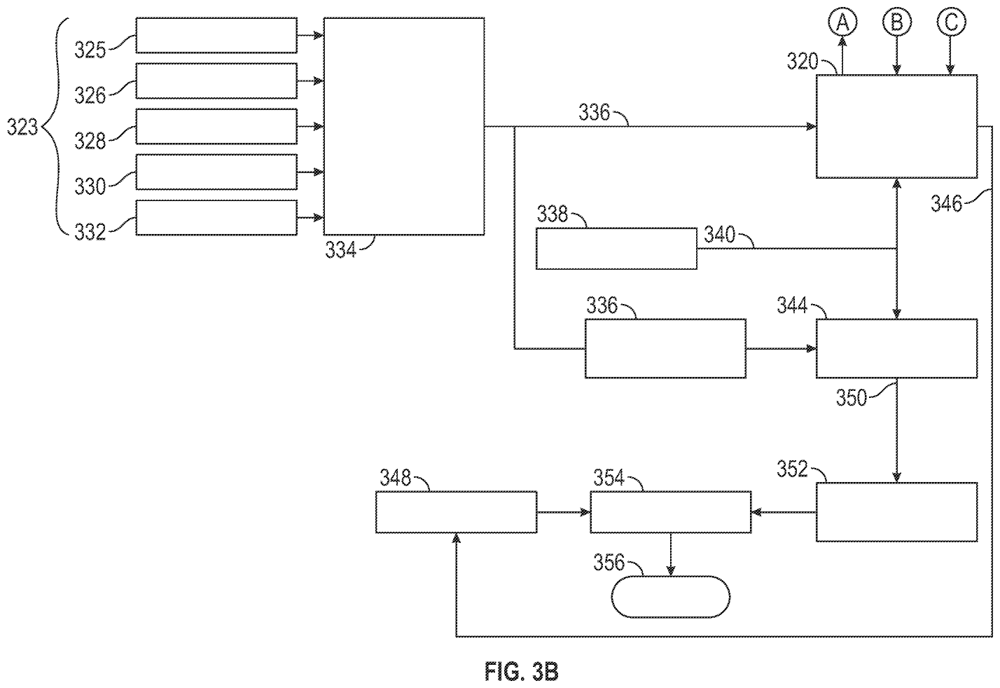

FIG. 1 illustrates a vehicle 100, according to an exemplary embodiment. As described in greater detail further below, the vehicle 100 includes, among other components, a rechargeable energy storage system (“RESS”) 101 and a control system 102. In various embodiments, the RESS 101 includes a plurality of cell groups 170 and a plurality of direct current to direct current (i.e., “DC” to “DC”) converters 172, for example as depicted in FIG. 2 and described in greater detail further below in connection therewith. Also in various embodiments, the control system 102 controls the RESS 101, including via control of operation of the converters 172 to optimize charge balance for the cell groups 170 and longevity of the RESS 101, including the converters 172 thereof, in accordance with the steps of the process 300 depicted in FIGS. 3A AND 3B and described in greater detail further below in connection therewith.

As depicted in FIG. 1, the RESS 101 and control system 102 are depicted as part of the vehicle 100 in accordance with exemplary embodiments. In various embodiments, the vehicle 100 comprises an automobile, such as any one of a number of different types of automobiles, such as, for example, a sedan, a wagon, a truck, sport utility vehicle (SUV), or the like. In certain embodiments, the vehicle 100 may also comprise a motorcycle or other vehicle, such as aircraft, spacecraft, watercraft, and so on, and/or one or more other types of mobile platforms (e.g., a robot and/or another mobile platform). In yet other embodiments, the RESS 101 and control system 102 may instead be part of and/or coupled to any number of other types of platforms and/or other systems, moving or non-moving, such as a building, infrastructure, and/or other platforms and/or other systems.

In the depicted embodiment, the vehicle 100 includes a body 104 that is arranged on a chassis 116. The body 104 substantially encloses other components of the vehicle 100. The body 104 and the chassis 116 may jointly form a frame. The vehicle 100 also includes a plurality of wheels 112. The wheels 112 are each rotationally coupled to the chassis 116 near a respective corner of the body 104 to facilitate movement of the vehicle 100. In one embodiment, the vehicle 100 includes four wheels 112, although this may vary in other embodiments (for example for trucks, motorcycles, and certain other vehicles).

A drive system 110 is mounted on the chassis 116, and drives the wheels 112, for example via axles 114. In certain embodiments, the drive system 110 comprises a propulsion system having a motor 113. In various embodiments, the drive system 110, including the motor 113, receives high voltage from the RESS 101.

In various embodiments, in addition to providing the high voltage to the motor 113, the RESS 101 also provides low voltage to one or more low voltage systems 111 of the vehicle 100. In various embodiments, the low voltage systems 111 may include, by way of example, one or more climate control systems, radio systems, seat warming systems, and so on.

As depicted in FIG. 1, the vehicle also includes a braking system 106 and a steering system 108 in various embodiments. In exemplary embodiments, the braking system 106 controls braking of the vehicle 100 using braking components that are controlled via inputs provided by a driver (e.g., via a brake pedal) and/or automatically via a control system (such as the control system 102 and/or one or more other control systems). Also in exemplary embodiments, the steering system 108 controls steering of the vehicle 100 via steering components that are controlled via inputs provided by a driver (e.g., via a steering wheel), and/or automatically via a control system (such as the control system 102 and/or one or more other control systems).

In the embodiment depicted in FIG. 1, the control system 102 is coupled to the RESS 101, receives inputs therefrom, and controls functionality thereof via control of the converters 172. In addition, in certain embodiments, the control system 102 is coupled to one or more of the braking system 106, steering system 108, drive system 110, and/or low voltage systems 111, and may also receive inputs from and/or control these additional systems in certain embodiments. In various embodiments, the control system 102 provides these functions in accordance with the process 300 as depicted in FIGS. 3A AND 3B and as described further below in connection therewith.

Also as depicted in FIG. 1, in various embodiments, the control system 102 includes a sensor array 120 and a controller 140, as described in greater detail below.

In various embodiments, the sensor array 120 includes various sensors that obtain sensor data of the vehicle 100 for use in controlling, among other functionality, the RESS 101, including the converters 172 thereof. In the depicted embodiment, the sensor array 120 includes one or more voltage sensors 130, current sensors 132, temperature sensors 134, state-of-charge sensors 136, brake sensors 137, and steering sensors 138. The sensors may be hardware-based sensors or virtual software equivalents.

In certain embodiments, the voltage sensors 130 measure voltage of the RESS 101, including of the various cell groups 170 thereof. Also in certain embodiments, the current sensors 132 measure electric current of the RESS 101, including of the cell groups 170 thereof. In various embodiments, the temperature sensors 134 measure temperature of the RESS 101, including of the cell groups 170 thereof. Also in various embodiments, the state-of-charge sensors 136 measure state-of-charge of the RESS 101, including of the cell groups 170 thereof. In addition, various embodiments, the brake sensors 137 measure one or more parameters pertaining to the braking system 106 (e.g., braking inputs, braking force, or the like), whereas the steering sensors 138 measure one or more parameters pertaining to the steering system 108 (e.g., steering inputs, steering angle, or the like).

In various embodiments, the controller 140 is coupled to the sensor array 120 and receives sensor data therefrom. In various embodiments, the controller 140 is further coupled to the RESS 101, including the converters 172 for control thereof. In addition, in certain embodiments, the controller 140 may also be coupled to one or more other systems of the vehicle 100, such as the braking system 106, steering system 108, drive system 110, and/or low voltage systems, for example for receiving input thereof and/or for controlling thereof.

In various embodiments, the controller 140 controls operation of the converters 172, including with respect to selective charging and discharging of the different cell groups 170 via the converters 172 in order to optimize balance for the cell groups 170 and/or longevity for the converters 172, among other potential functionality for the vehicle 100. In various embodiments, the controller 140 provides these functions in accordance with the steps of the process 300 that is depicted in FIGS. 3A AND 3B and described in greater detail further below in connection therewith.

As depicted in FIG. 1, in various embodiments, the controller 140 comprises a computer system (also referred to herein as computer system 140), and includes a processor 142, a memory 144, an interface 146, a storage device 148, and a computer bus 150.

The processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the controller 140 and the computer system of the controller 140, generally in executing the processes described herein, such as the process 300 of FIGS. 3A AND 3B and described further below in connection therewith.

The memory 144 can be any type of suitable memory, including various types of non-transitory computer readable storage medium. In certain examples, the memory 144 is located on and/or co-located on the same computer chip as the processor 142. In the depicted embodiment, the memory 144 stores the above-referenced program 152 along with stored values 157 (e.g., look-up tables, thresholds, and/or other values with respect to control of the RESS 101).

The interface 146 allows communication to the computer system of the controller 140, for example from a system driver and/or another computer system, and can be implemented using any suitable method and apparatus. In one embodiment, the interface 146 obtains the various data from the sensor array 120, among other possible data sources. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 152 that executes one or more embodiments of one or more processes of the present disclosure, such as the steps of the process 300 of FIGS. 3A AND 3B and described further below in connection therewith. In another exemplary embodiment, the program product may be directly stored in and/or otherwise accessed by the memory 144 and/or a disk (e.g., disk 156), such as that referenced below.

The bus 150 serves to transmit programs, data, status and other information or signals between the various components of the computer system of the controller 140. The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program.

FIG. 2 is a functional diagram of the RESS 101 of FIG. 1, and that includes a plurality of cell groups 170 and DC to DC converters 172, in accordance with exemplary embodiments.

As depicted in FIG. 2, in various embodiments, the RESS 101 includes a number of cell groups 170, such as a first cell group 170(1), a second cell group 170(2), and so on, up to an “nth” cell group 170(N). It will be appreciated that the number of cell groups 170 may vary in different embodiments.

Also as depicted in FIG. 2, and also in various embodiments, a number of DC to DC converters 172 are coupled to the cell groups 170. In the depicted embodiment, the converters 172 include a first converter 172(1), a second converter 172(2), and so on, up to an “nth” converter 172(N). As depicted in FIG. 2, in various embodiments each converter 172 comprises a DC to DC converter 172, and is coupled to one or more of the cell groups 170. It will be appreciated that the number of converters 172 may vary in different embodiments.

As depicted in FIG. 2, in various embodiments each converter 172 converts a source of direct current (DC) from one or more cell groups 170 from one voltage to another. In certain embodiments, current from one or more cell groups 170 may be selectively utilized for operation of different systems (such as of the vehicle 100 of FIG. 1) in a prioritized order based upon factors such as current states of charge and/or other conditions. In certain embodiments, as depicted in FIG. 2, current from various converters 172(1), 172(2), . . . 172(N) (namely, “i₀N”, “iₒ2”, . . . “iₒN”, respectively) may be aggregated as an aggregate current (namely, “is”) for use by the different systems. Also in certain embodiments, other electric current 176 may be stored and/or utilized for one or more other purposes, such as for rebalancing of the cell groups 170 (e.g., as described in greater detail further below in connection with FIGS. 3A AND 3B).

FIGS. 3A and 3B provide a flowchart of a process 300 for controlling an RESS, in accordance with an exemplary embodiment. In various embodiments, the process 300 includes the controlling of a DC to DC converters of an RESS, and can be implemented in connection with the vehicle 100 of FIG. 1, including the RESS 101 and control system 102 thereof, and the RESS 101 of FIG. 2.

As depicted in FIG. 3A, the process 300 begins at step 301. In one embodiment, the process 300 begins when the vehicle 100 is operated, for example during a current vehicle drive. In certain embodiments, the process 300 may also begin when the RESS 101 requires charging or discharging, and/or when the RESS 101 and/or control system 102 are active and/or in an awake or “on” state. In embodiment, the steps of the process 300 are performed continuously during the process 300.

In various embodiments, data is obtained (step 302). In various embodiments, sensor data is obtained from the sensor array 120 of FIG. 1, including data as to the cell groups 170 (including voltages, electric currents, temperatures, and states of charge thereof) and as to other vehicle data (such as vehicle braking, steering, and/or propulsion). In various embodiments, data may also be obtained as to the converters 172 (e.g., as to usage history of the various converters 172), among other possible data as to the vehicle 100, operation thereof, and/or conditions surrounding the vehicle 100, and so on.

In various embodiments, system loads are determined (step 303). Specifically, in various embodiments, electrical loads are determined for systems that require electric current, such as the low voltage systems 111 of the vehicle 100. In various embodiments, these determinations are made via a processor, such as the processor 142 of FIG. 1. Also in various embodiments, the system loads are utilized in step 303, described further below.

Also in various embodiments, determinations are made as to a required reserve for one or more systems for load changes (step 304). Specifically, in various embodiments, determinations are made as to a required reserve for noncontrolled load changes for systems that require electric current, such as the low voltage systems 111 of the vehicle 100. In various embodiments, these determinations are made via a processor, such as the processor 142 of FIG. 1. Also in various embodiments, these determinations are utilized in step 310, described further below.

Also in various embodiments, determinations are made as to requests and reserves (step 306). Specifically, in various embodiments, these determinations are made via one or more processors (such as the processor 142 of FIG. 1) using information as to available reserves 308 from the determinations of step 320 as to converter selection and power command (as described in greater detail further below).

In various embodiments, the determinations of step 306 as to the requests and reserves include an output as to an allowed controller load 322 that is utilized in determining one or more controlled loads for each of the converters 172. In various embodiments, these are determined via one or more processors (such as the processor 142 of FIG. 1).

Also in various embodiments, determinations are made as to a system required reserve (step 310). Specifically, in various embodiments, the determinations of step 310 are made via a processor (such as the processor 142 of FIG. 1) based on the system required reserve for load changes for systems required electric current (such as the low voltage systems 111 of the vehicle 100) as determined in step 304 and the requests and reserves as determined in step 306.

Also in various embodiments, determinations are made as to a system required power and reserve (step 312). Specifically, in various embodiments, the system required power and reserve are determined via a processor (such as the processor 142 of FIG. 1) based on the system loads as determined in step 303 and the system required reserve as determined in step 310 for systems required electric current (such as the low voltage systems 111 of the vehicle 100).

In various embodiments, a determination is made as to a number of converters (step 314). Specifically, in various embodiments, a processor (such as the processor 142 of FIG. 1) determines a number of converters 172 to be used for conversion of electric current from the cell groups 170 of FIGS. 1 and 2 in order to support the load requirements for systems required electric current (such as the low voltage systems 111 of the vehicle 100), including the necessary reserve and at the maximum efficiency. In various embodiments, this determination is made by the system required power and reserve as determined in step 312. In various embodiments, the output of this determination, namely a number 318 of converters, is utilized in step 320, as described further below.

Also in various embodiments, an output of step 312 (from the discussion above), namely the required power 316 (including reserve) as determined in step 312, is also utilized in step 320 (among various other inputs), also as described further below.

With reference now to FIG. 3B, in various embodiments, as the process 300 continues, various inputs are obtained at 323. Specifically, in various embodiments, the inputs of 323 include cell voltage 325, cell current 326, cell temperature 328, cell state-of-charge (SOC) 330 are utilized (along with other information 332, such as braking data, sensor data, and/or converter usage, among other possible information, in certain embodiments) in determining imbalance (step 334).

Specifically, in certain embodiments, during step 334, determinations are made as to imbalances in one or more of the cell groups 170. In various embodiments, these determinations apply to one or more state-of-charge (SOC) imbalances as to a relatively higher state-of-charge in certain cell groups 170 as compared with other cell groups 170, based on converter-based cell groupings, and so on. Also in various embodiments, these determinations are made by a processor, such as the processor 142 of FIG. 1, using the sensor data from the sensor array 120.

In various embodiments, the determinations of step 334 result in balance information 336 for each group of converters 172 that are used in both steps 320 and 344, as described in greater detail further below.

In various embodiments, diagnostics are performed at step 338. Specifically, in various embodiments, a processor (such as the processor 142 of FIG. 1) performs diagnostics as to which of the converters 172 of FIG. 1 have failed, are not functioning properly, and/or have been recently utilized to an extent such that further usage of such converters 172 at the present time would not be recommended. In certain embodiments, if any of these conditions are satisfied, then such converters 172 would be deemed to be unavailable during the current iteration of the process 300. Also in various embodiments, the diagnostics of step 338 results in output that results in a listing of unavailable converters 340, for example for use in steps 320 and 344, described below.

During step 320, in various embodiments, determinations are made as to converter selection and power command. Specifically, in various embodiments, one or more converters 172 of FIG. 1 are selected for converting electric current from one or more selected cell groups 170 for use by one or more systems (e.g., of the vehicle 100 of FIG. 1, such as the low voltage systems 111), and one or more power commands are determined and implemented with respect to the amount of power or current each converter 172 shall draw from its respective cell grouping to maintain balance. In various embodiments, these determinations are made by a processor (such as the processor 142 of FIG. 1) using the balance information 336 of step 334 and the listing of unavailable converters 340 from step 338, along with the required power 316 as determined in step 312 and the number of converters 318 as determined in step 314.

In certain embodiments, the determinations and/or selections of step 320 may vary. For example, in certain embodiments, in order to maintain balance, cell groups 170 with the highest state-of-charge may be utilized first, along with converters 172 that are coupled thereto. In certain imbalance, a time hysteresis may be utilized in conjunction with the cell group balancing. In certain other embodiments, a round robin technique may be utilized to alternate usage of the converters 172 and the cell groups 170 coupled thereto.

In various embodiments, the output of step 320 includes measures of both available reserves 308 and converter commands 346, both of which are determined via a processor (such as the processor 142 of FIG. 1). In various embodiments, the available reserves 308 are utilized in step 306, as described above.

Also in various embodiments, the converter commands 346 include commands for operation of selected converters 172, which are selected in step 320 for the conversion of electric current from selected respective cell groups 170, along with power commands for the operation of the selected converters 172. In various embodiments, converter selection and power commands are made by the processor in order to help maintain balance among the various cell groups 170 and further in order to enhance longevity of operation for the converters 172, based on the balance information 336, unavailable converters 340, required power 316, and number of converters 318. Also in various embodiments, the converter commands 346 are utilized in step 348, described below.

In various embodiments, during step 348, the converter commands 346 from step 320 are implemented. Specifically, in various embodiments, the selected converters 172 provide conversion for electric current of selected cell groups 170 for use by one or more systems requiring electric current or power, such as the low voltage systems 111 of FIG. 1. In certain embodiments, one or more additional actions may also be taken, as described in greater detail further below in connection with step 354.

With reference back to step 334 and the balance information 336 resulting therefrom, as noted above, in various embodiments the balance information 336 is also utilized in step 344. Specifically, in various embodiments, during step 344, supplemental balancing is performed. In various embodiments, additional (or supplemental) balancing of the cell groups 170 is performed, separate from and apart from the electric current used for the systems (such as the low voltage systems 111 of FIG. 10f the vehicle 100) requiring electric current or power.

In certain embodiments, during step 344, the supplemental balancing is performed by transferring electric current between various cell groups 170 of FIG. 2 via one or more converters 172 of FIG. 2, and/or from providing electric current to and/or retrieving electric current via the cell groups 170 via one or more converters 172 of FIG. 2 (e.g., via a vehicle electric current repository, in certain embodiments). Specifically, in certain embodiments, if any converters 172 have failed or are otherwise unavailable, then converter based balancing may not be able to perform appropriately, such that secondary balancing may be required. In addition, in certain embodiments, if cell balancing by varying the converter loads is insufficient, then secondary balancing may be applied in order to maintain the overall pack balance. In certain embodiments, the supplemental balancing corresponds to electric current 176 as depicted in FIG. 2. In addition, in various embodiments, the supplemental balancing is performed in accordance with instructions provided by one or more processors (such as the processor 142 of FIG. 1) to one or more of the converters 172.

In various embodiments, the supplemental balancing of step 344 results in cell balancing commands 350 that are provided by one or more processors (such as the processor 142 of FIG. 1) and that are implemented by one or more converters (such as one or more of the converters 172 of FIGS. 1 and 2). In certain embodiments, one or more additional actions may also be taken, as described in greater detail further below in connection with step 354.

In various embodiments, during step 354, one or more additional actions may be taken (for example, in addition to the converter commands 346 that are implemented by the converters in step 348 and in addition to the cell balancing commands 350 that are implemented in step 354). Specifically, in certain embodiments, electric current or power provided to the low voltage systems 111 may be prioritized and/or adjusted, for example on a temporary basis as needed to conserve energy and/or power or maintain cell group balance and/or converter longevity, and so on, among other possible actions.

For example, in certain embodiments, voltage loads may be disallowed, diminished, and/or delayed in certain circumstances (e.g., based on available voltage loads and/or reserves) to certain systems (e.g., a passenger seat warming systems) that may provide non-essential functionality, whereas voltages for more critical functionality (e.g., for vehicle braking and steering) may be fully allowed. In addition, in certain embodiments, voltage reserves may be built up for such systems (including those of relatively lower priority) for use when available. In addition, in certain embodiments, one or more bi-directional converters 172 may be utilized, for example to take energy as needed from a vehicle voltage bus and place the energy into one or more of the cell groups 170 (e.g., if the state-of-charge of such cell groups 170 is low), and/or to help cycle from one cell group 170 to another cell group 170 (e.g., if the state-of-charge of one cell group 170 is high while that of another cell group 170 is low, and so on), among other possible actions.

In various embodiments, the process 300 then terminates at step 356.

Accordingly, methods, systems, and vehicles are provided for controlling a DC to DC converter system, for example as part of an RESS of a vehicle in certain embodiments. Specifically, in various embodiments, the methods and techniques described herein help to maintain cell group stability and balance of charge while maintaining longevity of the converters. In various embodiments, these techniques help to create a margin in the low voltage systems that require electric current or power, while also determining how to cycle the load between converters in a varying fashion to accomplish the multiple goals, of maximizing converter efficiencies, balancing the energy drawn from each segment of cells, and providing the required stability and transient response on the low voltage output. In addition, in various embodiments, the methods and techniques also address converters that have power limitations as well as failed and/or unavailable converters and adjust the sequencing accordingly (e.g., so as to not utilize the failed or unavailable converters). Further, in various embodiments, the disclosed methods and systems provide for secondary cell balancing mechanisms if the converters are not sufficient to maintain cell balancing, among other potential benefits.

It will be appreciated that the systems, vehicles, and methods may vary from those depicted in the Figures and described herein. For example, the vehicle 100 of FIG. 1, including the RESS 101, control system 102, and/or other components thereof, may vary in different embodiments from that depicted in FIG. 1 and/or described above in connection therewith. It will also be appreciated that the RESS 101 and/or components thereof and/or implementation thereof may also differ from that depicted in FIG. 2 and/or as described above in connection therewith. It will similarly be appreciated that the steps of the process 300 may differ from that depicted in FIGS. 3A and 3B, and/or that various steps of the process 300 may occur concurrently and/or in a different order than that depicted in FIGS. 3A and 3B and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for controlling a plurality of converters that are coupled to a plurality of cells of a rechargeable energy storage system (RESS) and that are configured to supply electric current to one or more other systems that require the electric current, the method comprising:
obtaining, via one or more sensors, cell data as to the plurality of cells, the cell data including a state-of-charge for each of the plurality of cells;
obtaining other system data as to the one or more other systems, including an amount of electric current required by the one or more other systems; and
controlling the plurality of converters, in accordance with instructions provided by a processor, based on both:
the cell data, including the state-of-charge for each of the plurality of cells; and
the other system data, including the amount of electric current by each of the one or more other systems.

2. The method of claim 1, wherein the controlling of the plurality of converters comprises:
selecting, via the processor, a selected converter group of the plurality of converters and a selected cell group of the plurality of cells that are coupled to the selected converter group, to be utilized for providing the electric current to the one or more other systems; and
selecting, via the processor, electric current commands for a magnitude of the electric current to be provided via the selected converter group and the selected cell group to the one or more other systems.

3. The method of claim 2, wherein the selected converter group and the electric current commands are selected via the processor to facilitate balancing of states of charge of the plurality of cells.

4. The method of claim 3, further comprising:
obtaining converter data as to operation of the plurality of converters;
wherein the selected converter group and the electric current commands are also based on the converter data that also accounts for any unavailable converters and to facilitate longevity for the plurality of converters.

5. The method of claim 4, wherein the steps of the method are performed within a vehicle that includes the RESS, including the plurality of cells and the plurality of converters, and further including the one or more sensors, the processor, and the one or more other systems, and wherein of the plurality of converters comprise a direct current (DC) to direct current (DC) converter.

6. The method of claim 3, further comprising:
providing supplemental commands, via the processor, for supplemental balancing of the plurality of cells, separate and apart from the electric current commands.

7. The method of claim 2, further comprising:
adjusting the electric current commands based on a reserve of the electric current that is available in addition to a prioritization of the one or more other systems, including based on a respective relative criticality of the one or more other systems.

8. A system for controlling a plurality of converters that are coupled to a plurality of cells of a rechargeable energy storage system (RESS) and that are configured to supply electric current to one or more other systems that require the electric current, the system comprising:
one or more sensors configured to obtain cell data as to the plurality of cells, the cell data including a state-of-charge for each of the plurality of cells; and
a processor that is coupled to the one or more sensors and that is configured to at least facilitate:
obtaining other system data as to the one or more other systems, including an amount of electric current required by the one or more other systems; and
controlling the plurality of converters, in accordance with instructions provided by the processor, based on both:
the cell data, including the state-of-charge for each of the plurality of cells; and
the other system data, including the amount of electric current by each of the one or more other systems.

9. The system of claim 8, wherein the processor is further configured to at least facilitate controlling the plurality of converters by:
selecting a selected converter group of the plurality of converters and a selected cell group of the plurality of cells that are coupled to the selected converter group, to be utilized for providing the electric current to the one or more other systems; and
selecting electric current commands for a magnitude of the electric current to be provided via the selected converter group and the selected cell group to the one or more other systems;
wherein the electric current commands are implemented via the selected converter group of the plurality of converters.

10. The system of claim 9, wherein the processor is further configured to at least facilitate selecting the selected converter group and the electric current commands to facilitate a balancing of states of charge of the plurality of cells.

11. The system of claim 10, wherein the processor is further configured to at least facilitate:
obtaining converter data as to operation of the plurality of converters; and
selecting the selected converter group and the electric current commands based also on the converter data in a manner that also accounts for any unavailable converters and to facilitate longevity for the plurality of converters.

12. The system of claim 10, wherein the processor is further configured to at least facilitate:
providing supplemental commands for supplemental balancing of the plurality of cells, separate and apart from the electric current commands.

13. The system of claim 9, wherein the processor is further configured to at least facilitate:
adjusting the electric current commands based on a reserve of the electric current that is available in addition to a prioritization of the one or more other systems, including based on a respective relative criticality of the one or more other systems.

14. A vehicle comprising:
a rechargeable energy storage system (RESS) that includes a plurality of cells and a plurality of converters that are coupled thereto and that are configured to supply electric current;
one or more other systems that require the electric current and that receive the electric current from the RESS; and
a control system comprising:
one or more sensors configured to obtain cell data as to the plurality of cells, the cell data including a state-of-charge for each of the plurality of cells; and
a processor that is coupled to the one or more sensors and to the plurality of converters, and that is configured to at least facilitate:
obtaining other system data as to the one or more other systems, including an amount of electric current required by the one or more other systems; and
controlling the plurality of converters, in accordance with instructions provided by the processor, based on both:
the cell data, including the state-of-charge for each of the plurality of cells; and
the other system data, including the amount of electric current by each of the one or more other systems.

15. The vehicle of claim 14, wherein:
the processor is further configured to at least facilitate controlling the plurality of converters by:
selecting a selected converter group of the plurality of converters and a selected cell group of the plurality of cells that are coupled to the selected converter group, to be utilized for providing the electric current to the one or more other systems; and
selecting electric current commands for a magnitude of the electric current to be provided via the selected converter group and the selected cell group to the one or more other systems; and
the electric current commands are implemented via the selected converter group of the plurality of converters.

16. The vehicle of claim 15, wherein the processor is further configured to at least facilitate selecting the selected converter group and the electric current commands in a manner that facilitates a balancing of states of charge of the plurality of cells.

17. The vehicle of claim 16, wherein the processor is further configured to at least facilitate:
obtaining converter data as to operation of the plurality of converters; and
selecting the selected converter group and the electric current commands based also on the converter data that also accounts for any unavailable converters and to facilitate longevity for the plurality of converters.

18. The vehicle of claim 16, wherein the processor is further configured to at least facilitate:
providing supplemental commands for supplemental balancing of the plurality of cells, separate and apart from the electric current commands.

19. The vehicle of claim 18, wherein one or more of the plurality of converters comprises a bidirectional converter, and the providing of the supplemental commands is provided by the processor and implemented by the bidirectional converter for the supplemental balancing of the plurality of cells, separate and apart from the electric current commands.

20. The vehicle of claim 15, wherein the processor is further configured to at least facilitate adjusting the electric current commands based on a reserve of the electric current that is available in addition to a prioritization of the one or more other systems, including based on a respective relative criticality of the one or more other systems.
